(19) United States
(12) Patent Application Publication
(10) Pub. No.: US 2026/0162056 A1
(43) Pub. Date: Jun. 11, 2026

(54) METHODS AND APPARATUS FOR ARTIFICIAL INTELLIGENCE BASED LEARNING AND PREDICTION FOR PACKAGING

(71) Applicant: Plastic Free Future Inc., New Richmond, OH (US)

(72) Inventors: Anand Narasimhan, London (GB); Deborah A. Adams, New Richmond, OH (US); Phillip Andrew Patrick, Carpinteria, CA (US)

(21) Appl. No.: 19/415,928

(22) Filed: Dec. 11, 2025

Related U.S. Application Data
(60) Provisional application No. 63/730,524, filed on Dec. 11, 2024.

(51) Int. Cl. G06Q 10/083

(52) U.S. Cl. CPC G06Q 10/0843; G06Q 10/0841

(57) ABSTRACT

A computer-implemented system and method for analyzing, optimizing, and managing packaging designs are disclosed. The system includes databases for packaging designs, materials, regulatory requirements, testing results, suppliers, and supply chain risks. A digital twin module models lifecycle and performance characteristics of packaging. A machine learning engine evaluates designs using performance metrics, cost structures, manufacturability constraints, compliance rules, supply chain considerations, and optional sustainability attributes. A recommendation engine generates design alternatives, material substitutions, supplier matches, and predicted outcomes. A collaborative interface enables designers, buyers, engineers, manufacturers, testers, and compliance providers to interact with the system. The system may generate compliance documentation or other outputs supporting design, production, and procurement decisions. The methods allow users to upload packaging designs, simulate lifecycle or performance behavior, identify deficiencies, and iteratively optimize packaging for cost, performance, manufacturability, compliance, supply chain behavior, or sustainability.

### CROSS REFERENCE TO RELATED APPLICATION

This application claims priority to U.S. Provisional Ser. No. 63/730,524 , filed Dec. 11, 2024, entitled “METHODS AND APPARATUS FOR ARTIFICIAL INTELLIGENCE BASED LEARNING AND PREDICTION FOR SUSTAINABLE PACKAGING,” the disclosure of which is expressly incorporated by reference in its entirety.

### BACKGROUND

Transformation of the global, fragmented packaging ecosystem is challenging. Current solutions are insufficient, manual and siloed. Buyers find it difficult to identify innovative materials and their manufacturers, to adequately analyze the lifecycle impact of such materials and to innovate packaging structural designs, to test, analyze, prototype, and manufacture them in global destinations, and to manage the supply chain variables and risks all the way to end-of-use producer responsibilities. Further, regulations on unsustainable materials such as plastics are increasingly emerging, adding layers of complexity, user responsibilities, and taxation.

The packaging ecosystem today relies on various entities, often decoupled from each other. Designers rely on standalone tools, decoupled from lifecycle analysis or other supply chain parameters. Testers, prototypers and compliance providers rely on manual processes, and are often limited to local, niche markets. Lifecycle analysis is a complex process, and requires expertise and long, iterative cycles. Regulatory compliance requires local consultants, with manual processes for determining reporting and taxation obligations. Data across the value chain is spotty and incomplete and cannot be used to derive meaningful insights for continuous improvement across the value chain. Consumers demand transparency, yet buyers find it difficult to engage the sustainable packaging value chain.

Emerging from these observations is a key insight that transformation toward more sustainable materials requires the active engagement of the entire packaging ecosystem, with intelligence to learn and predict pathways to sustainability that are optimized across multiple dimensions of the value chain. The present disclosure relates to a system that addresses this transformational challenge.

### SUMMARY

The present disclosure describes a system that offers a unified, networked interface, enabling participation and collaboration for all entities in a packaging value chain, including but not limited to buyers, material innovators, designers, testers, prototypers, manufacturers, and compliance providers.

Buyers can upload current packaging designs and associated content, and instantly view a digital twin of the design's entire value chain. This includes life cycle analyses across the product lifecycle, trade-offs on cost, suppliers, supply chain risks, compliance, sustainability and circularity. Buyers can discover new materials, iterate packaging structural and material designs, test rapidly, buy, track, and be compliant. Digital passports enable transparency for consumers, offering them views of the packaging product's provenance and lifecycle. Buyers can model future pathways to improve sustainability and share substantiated claims of provenance, compliance and sustainability.

Material manufacturers can upload new material specifications, obtain instant lifecycle analyses, advertise and market their capabilities, enabling discovery by potential buyers.

Designers and other service providers can advertise their services, get matched for specific services, upload results, visualize digital twins and optimize across the supply chain. This offers a powerful way for providers to attract customers and grow, while enabling a broader sustainability transformation.

Underlying these capabilities are several core capabilities, as part of the present disclosure. A co-pilot enables users to easily query and discover new materials optimized for supply chain parameters, including design, locations, compliance, suppliers, testing, certification, cost, availability, logistics, risks, sustainability and circularity. A digital twin enables a comprehensive view of parameters across multiple dimensions that must be optimized. A machine learning engine learns across all aspects of the supply chain, such as performance, cost, manufacturability, supply chain risk, compliance and/or sustainability, so that a multi-objective prediction engine can optimize across the supply chain and recommend potential pathways for continuous improvement towards sustainable outcomes. Generative artificial intelligence can answer multi-modal queries about current designs, comparisons and recommendations, create reports for submission of compliance documents to track upcoming legislation, and create documentation to transparently assert claims of conformance and sustainability that can be subsequently verified through actionable data and insights.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

For the purpose of illustrating the disclosed implementations, there is shown in the drawings example constructions of the implementations; however, the possible implementations are not limited to the specific methods and instrumentalities disclosed for automated quality management. In the drawings:

FIG. 1 is a schematic diagram of various users interacting with the system, according to the embodiment.

FIG. 2 is a schematic diagram of a software architecture that can be used to implement the system, according to the embodiment.

FIG. 3 is a flowchart diagram showing a mechanism of the learning engine, according to the embodiment.

FIG. 4 is a flowchart diagram showing a mechanism of the learning and prediction engines, analysis of packaging designs, generative AI responses to user queries for improved designs and for the best providers of a selected service, according to the embodiment.

FIG. 5 is a flowchart diagram showing a mechanism for the response to a user query about digital product passports, the response to a query for pathways to ensure future compliance to regulations, and for future sustainability, according to the embodiment.

FIG. 6 is an example of a graphical user interface, for a user of the system designing a packaging object with an objective to optimize the design across multiple entities and processes in a supply chain, according to the embodiment.

### DETAILED DESCRIPTION

This detailed description highlights various aspects and embodiments without imposing any limitations on the scope of the disclosure. The following description and accompanying illustrations aim to enable those skilled in the art to make and use the disclosed implementations. While certain aspects, advantages, and novel features of the disclosure have been described and illustrated, the subject matter of the disclosure is not limited to the embodiments disclosed, as variations and modifications can be made without deviating from the spirit of the disclosure.

The detailed description of an embodiment are not exhaustive and are intended to offer a clear and comprehensive understanding of the disclosure. Furthermore, the embodiments described herein are not mutually exclusive, as various combinations and permutations of these embodiments may be apparent to those skilled in the art.

Throughout the description, the use of terms such as “a,” “an,” and “the” should be interpreted as encompassing both singular and plural forms, unless otherwise specified. Additionally, the use of ordinal numbers, such as “first,” “second,” and “third,” is solely for identification purposes and does not imply an order of importance or temporal sequence.

The components, elements, or structures described in this detailed description are not limited to their specific orientations or configurations as illustrated or described. These components, elements, or structures may be rearranged, reoriented, or modified without deviating from the scope of the disclosure.

In describing the implementations, numerous specific details may be set forth to provide a comprehensive understanding. However, it should be recognized that the subject matter of the disclosure can be practiced without the specific details, or with equivalent or alternative components, methods, and materials.

The detailed description provided herein serves to elucidate various aspects, embodiments, and features of the implementations. It should be apparent to those skilled in the art that modifications, variations, and equivalents may be made without departing from the scope and spirit of the disclosure.

The present disclosure relates to systems and methods for packaging design, redesign, evaluation, and optimization. More particularly, the disclosure relates to artificial intelligence systems, digital twins, multi-objective optimization, materials intelligence, design automation, supplier matching, regulatory forecasting, and lifecycle evaluation applicable to all packaging types and use cases, including but not limited to performance improvement, cost reduction, manufacturability, regulatory compliance, supply chain optimization, and sustainability.

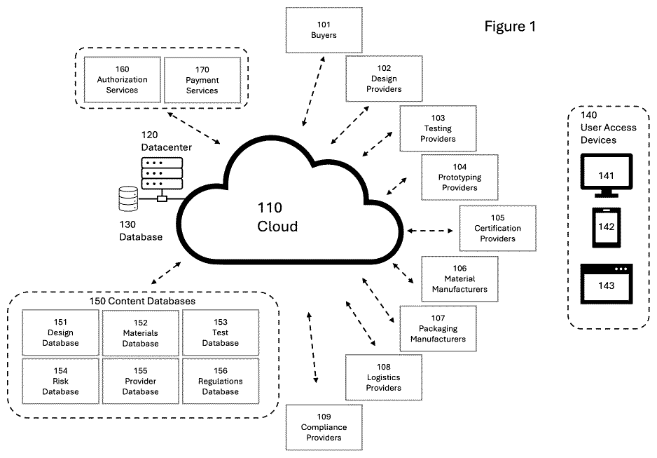

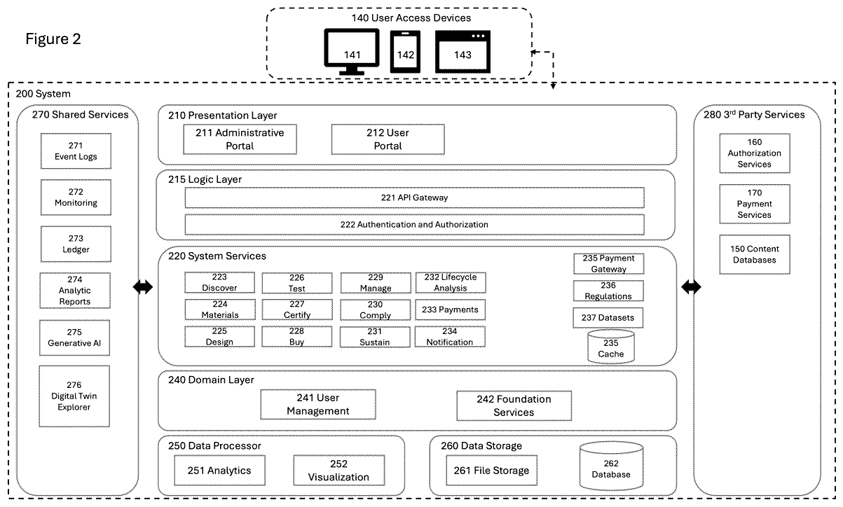

FIG. 1 is a schematic diagram of an agile packaging system (henceforth called SustainAgility or SA or by reference to 200 in FIG. 2), according to an embodiment, showing various entities interacting with processes in the system. These entities are operatively coupled with User Access Devices 140, through which the functionalities of SA are accessed. 140 can represent a computer 141, mobile device 142, or handheld device 143, or any other form of physical or virtual interface employing textual, audiovisual, or other time series data to interact with SA. The various entities are illustrated as 101 (Buyers of packaging designs, services and products), 102 (service providers who offer design services for rendering designs for packaging products), 103 (testing service providers who provide services for testing packaging designs and products to ensure performance adherence to test specifications or standards), 104 (prototyping service providers who offer services to build prototypes of packaging designs to enable testing, user review or other acceptance criteria), 105 (certification providers who provide services to ensure that packaging designs conform to specific certification criteria or standards), 106 (material manufacturers who produce materials that can be used to build packaging products), 107 (packaging manufacturers who build packaging products based on design specifications), 108 (logistics providers who provide services relating to distribution, storage and transport of packaging products), and 109 (compliance providers who offer one or more services to evaluate, report and conduct tasks related to the compliance of packaging products to specific regulations in specific jurisdictions). These entities interact with SA through the internet cloud 110, a globally connected network that enables interaction among connected entities.

Datacenter 120 represents an instance of a computing environment wherein computing, storage and networking, amongst other functionalities, enable the running of the system of SA, and interaction with other entities connected to 110. Database 130 represents temporary or long-term memory organized in structured or unstructured formats enabling dynamic, efficient access and manipulation of data for SA. In addition to 130, there are several specialist Content Databases 150, providing information about specific dimensions that are important to the packaging lifecycle, which can evolve over time. Design database 151 is an extensive database of packaging designs intended for various use case scenarios in various industries and markets, each with detailed specifications of 2-dimensional and 3-dimensional constructs, among other parameters that are important for the description of the physical or digital structure, functionality and disposition of packaging products. Materials database 152 is a database of materials that are used to create packaging products. This can include material characteristics, chemical compositions, interactions, performance characteristics, limitations, and other properties of materials that can be relevant to the use of materials in packaging products.

Test database 153 is a database of various test standards that align with different packaging products, materials, industries and use case scenarios, among other aspects. It also includes test results of various designs in 151 and materials in 152, as well as designs and materials that various entities 101-109 introduce into SA. Risk database 154 is a database of risks associated with the supply chain for packaging, with internal risks within SA or the supply chain, or risks due to externalities. Examples of internal risks could include material unavailability due to supplier production issues, or transportation issues due to logistics equipment failures. Examples of externalities include adverse weather, conflicts, political issues, among other factors outside of the influence of the packaging supply chain.

Provider database 155 is a database of providers of various services in the entire packaging ecosystem. This includes instances of all entities 101-109, and potentially larger sets of such providers who may not yet be participants in SA. Regulations database 156 is an illustrative database of relevant regulations in various jurisdictions around the world, which pertain to packaging products, with potential requirements that restrict or enable the packaging ecosystem, and with penalties or rewards for various types of non-compliance or compliance. Such regulations can also include work-in-progress regulations that are being developed for future implementation, and that can provide early guidance and planning counsel for the packaging ecosystem. Further enabling the system SA are authorization service 160, that serves to create a form of secure user authentication and access control for users of SA, and payment services 170 that provides mechanisms for payment of compensation for various services, amongst users of SA.

It is noted that SA may be used not only for designs that seek to optimize sustainability of packaging, but also may be used across the entire packaging industry to support design scenarios, such as but not limited to, cost optimization, structural performance, manufacturability, regulatory compliance, supplier selection, and branding changes.

FIG. 2 is a schematic diagram illustrating an embodiment 200 of the system SA. User access devices 140 can access system 200 through a network, such as the public cloud 110, or in other embodiments, through any network that supports network protocols like HTTPS. IN system 200, presentation layer 210 provides access to various forms of user experiences, based on access and role permissions, as well as user preferences for selection of functionalities, form and appearance, among other flexibilities that user experiences might require. In this embodiment, an administrative portal 211 enables administrators of system 200 to access functionalities of the system for purposes of administrating functionalities and experiences. User portal 212 enables various users of the system to access system functionalities in various role additional to that of the administrator role. Next, logic layer 215 offers two key functionalities, among others. An application programming interface (API) gateway enables a variety of user experiences via programmatic interfaces that can access granular system 200 functionalities.

Authentication and authorization 222 enables a method for various users to authenticate securely with system 200, and to engage with the system through specific authorizations for functionalities that can be accessed. System services 200 is a collection of services that can be accessed separately or in combination, to enable the various functionalities of 200. Discover service 223 enables users to discover new designs and materials for packaging, based on user provided requirements, or using inputs from users on their uploaded designs and specifications as guidelines for the discovery of new pathways. These could be optimized for specific dimensions or created as an output of a multi-dimensional optimization, including dimensions such as materials, locations, lifecycle analysis, test standards and requirements, certification standards, supplier capabilities and performance, supply chain parameters, compliance requirements, sustainability and circularity metrics. Other dimensions are possible in different embodiments, which can extend the functionality provided by 223.

Materials service 224 enables access and discovery of materials suitable for specific packaging design and use scenarios and draws from the materials database 152. This is typically an extensive database, with various dimensions for selection and refinement, including material composition, properties, impact, standards, certifications, brands, restrictions, and more. Design service 225 enables users to design new packaging types, and to upload existing designs with the purpose of creating derivative or different designs created through analysis, comparison and recommendations that draw upon multi-dimensional optimization offered by system 200. Test service 226 is an embodiment of a service that can be used to virtually test a packaging material or design, for specific criteria or against one or more test standards, or to request services from a test provider who can perform test services physically or virtually. Tests can include several aspects, including but not limited to structural testing for dimensions, integrity, load, and shock, or thermal testing for properties under varying temperatures, or brand appeal with customers in varied market scenarios. Test results can further contribute to test database 153, to expand its data set and enhance further system 200 learning and prediction capabilities.

Certify service 227 enables capabilities to ascertain whether a specific design meets the criteria for acceptance to one or more certification standards, or to identify certification providers who can perform certification services. Buy service 228 enables the purchase of services from various providers such as those described by 102-109, or to buy packaging materials or products that can be manufactured by providers such as 106 and 107. In one embodiment of the Buy service 228, each participating entity's ownership of information, permissions to use, and information pricing models are maintained at a granular level, so that attribution of ownership, along with a permissions model and a compensation model can be stablished. The Buy service 228 tracks these details and ensures that attributes, permissions and compensation are manages in a fair and just way. Such transactions are also subsequently written to ledger 273, for potential future verification and resolution.

System service 229 enables management of supply chain parameters in relation to services or products purchased via service 228, or to model supply chain parameters for any material through service 224 or design through service 225. Supply chain parameters can be quite extensive, and examples of such parameters include fill rate, order cycle time, on time shipping, perfect order rate, back order, rate of return. Parameters can also include various intrinsic or extrinsic risks to the supply chain, such as political, environmental, regulatory or social risks. System service 230 enables compliance to regulations in various jurisdictions, by digesting content of regulatory standards and information to create policies, constraints and actions, and applying them to the context of specific user-design-packaging supply chain instances and offering pathways for compliance through optimized changes to one or more aspects pertaining to the instance. In one embodiment, regulatory documentation from various sources are received by the system, as inputs into an artificial intelligence learning model for textual analysis, and reasoning algorithms to determine policies that can be further applied to inform the creation of regulatory pathways that offer optimum compliance while also optimizing the packaging design to improve sustainability or other aspects of the packaging design, as described herein.

System service 231 is an instance of a sustain service that computes various metrics related to packaging designs, materials and sustainability across a supply chain. Such metrics could include indicators of emissions, energy, climate, water use, ecology, health, social, environmental and governance, return on investment, as well as metrics associated with various sustainability related reporting standards in various jurisdictions. System service 231 also relies on the computation of lifecycle analysis metrics that are computed in system service 232, that incorporate various data sets and assumptions about the entire lifecycle of a packaging product across a supply chain.

System service 233 manages payments, as compensation for services or products, amongst various entities participating in the functioning of system 200. This service also utilizes payment gateway 235 to connect to an external 3^{rd} party service 170 to conduct financial transactions across the network. System service 234 provides notifications of various events that may be relevant, required or beneficial to participating entities. Examples of such notifications could be the emergence of a novel material that improves the overall sustainability of a specific packaging design, or the emergence of a new, upcoming regulation that could have an adverse impact on a specific packaging design. Various 3^{rd} party services can be introduced into an embodiment, such as shown in component 280, comprising 160 which is an authorization service to enable authorization and access to various functionalities of the system utilizing identity information that can be securely shared across trusted parties, component 170 which is a payment gateway that connects to various financial institutions to process a financial transaction initiated within component 233 and facilitated via component 235. And until 150, which have previously been described as content database.

Component 236 serves to maintain specifically structured content drawn from regulations database 156, to facilitate access and manipulation into actionable policies within system 200. 237 organizes a subset of data drawn from various databases in 150, to enable efficient access to system 200, and stores such information in a cache of component 235, designed for the purpose of efficient retrieval, modification and use. Next is the domain layer 240, which primarily provides user management services in component 241, and controls all user access from component 140 through the layers of system 200, as well as component 242, which provides foundational services to enable the proper functioning of all the layers and services of system 200.

Component 250 is a data processor, with constituent component 251 to process analytics across all relevant datasets, and component 252, which serves to create meaningful visualizations of analytical results that can offer actionable visual representations to user interfaces that are made available via devices in component 140. Data storage component 260 comprises various organized data stores, including component 261 which enables storage of relevant files, and component 262 which is the main database for system 200, housing all structured and unstructured data of relevance to the functioning of 200 and its users.

Component 270 represents a group of shared services, which offer functionalities leveraged by system services 220. Component 271 holds logs of all system 200 actions and transactions, serving as a record for future utilization of one or more participating entities of the system 200. Component 272 performs monitoring of specified actions and sequence of actions across system 200, can be called by any system service 220 to perform monitoring. Component 273 is a specific instance of a ledger, designed to serve as an immutable record of specific events, which can be drawn from event log 271, or from any system service 220. In one embodiment, ledger entries form the basis for generation of a digital passport, essentially a chronological record of events intended to establish the provenance of a packaging object or material and key features that track its pathway across the supply chain.

Component 274 produces analytical reports, which can be utilized within system services 220, and leverage component 250 functionalities to produce analytics that are specific to each of services 220 or to any combination of those services. Component 275 provides generative artificial intelligence (AI) services, proving the ability to respond to a multi-modal user query through any system service 220 and providing context-specific responses that can be informative or actionable.

Component 276 is a digital twin explorer, serving to create a virtual instance of a physical or digital entity, with the ability to track, analyze and evaluate its features and to model future evolution pathways. Component 276 may generate computational representations of packaging designs and simulates lifecycle behaviors including structural performance, material flow, manufacturing constraints, logistics behavior, and end-of-life pathways. The model may incorporate or omit sustainability metrics depending on the user's objectives. In an example embodiment, the digital twin is represented through a graph model of various dimensions, such as materials, locations, lifecycle analysis, tests, certification, suppliers and providers, supply chain parameters, compliance and sustainability. A graph representation facilitates the discovery of relationships between features of these various dimensions, and further distinguishes the ability of generative AI component 275 to produce more nuanced and detailed responses to user queries. In addition, digital twin may may be used to represent performance, cost, manufacturability, supply chain risk, and compliance.

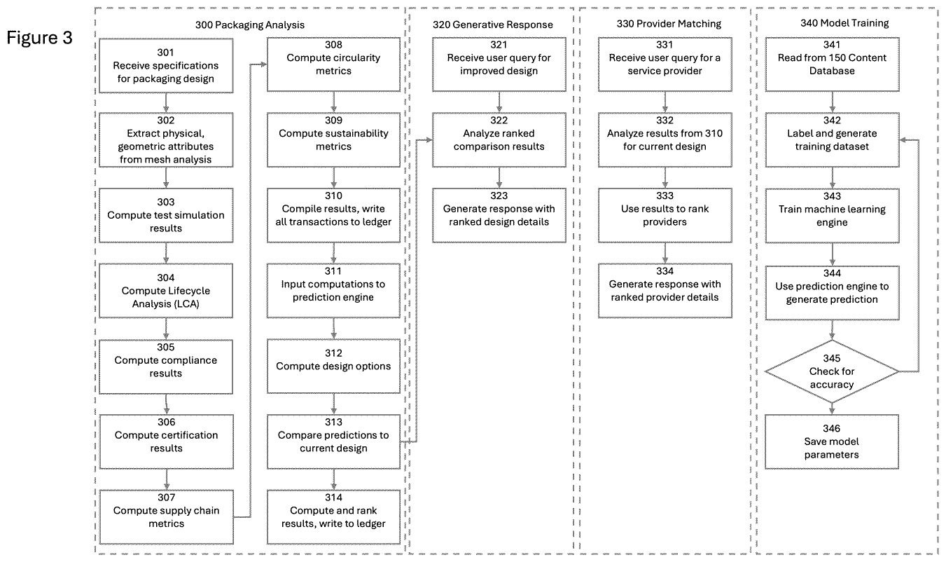

FIG. 3 is a flowchart illustration of the processes 300 for packaging analysis, for a generative response 320 to a user query for improved packaging design, for a provider matching functionality 300, and for a process 340 of model training for the training engine and prediction engine. In an embodiment of the processes 300, specifications of a packaging design are received in 301, leading to 302 which performs a mesh analysis to extract useful physical and geometric attributes of the packaging object's design. Once these attributes or features are extracted, 303 performs a test simulation to virtually evaluate the performance of the packaging design in potentially future real-world scenarios. In one embodiment, these tests can include load drop tests, thermal tests at high temperatures to evaluate internal and external performance of the packaging structural and material design, and load tests to examine the physical constraints of the packaging object and its constituent materials. The next step is in 304, where an LCA is computed, modeling the lifecycle of the packaging design across the supply chain, usage scenarios, as well as end-of-life disposition.

Next, at 305 evaluates the packaging design against known certification standards, to examine whether the design meets or exceed the criteria of such certifications. At 307 the process then evaluates various supply chain metrics. In one embodiment, these include manufacturing metrics for specific potential manufacturers of the packaging design, as well as potential logistics providers and their distribution systems. Next, at 308, the process computes circularity metrics. In one embodiment, circularity metrics include product level metrics as well as system level metrics that incorporate dynamics across the entire supply chain, including economic, environmental, and social dimensions of circularity. Next, at 309, the process computes sustainability metrics. These can be across multiple dimensions, such as energy, water, emissions, and waste, among others. They can also include various metrics from sustainability standards.

Next, at 310, the process compiles the results of all the computations in 300, and relevant transactions are written to ledger 273, for future use in requests for immutable records of transactions. Then, these compiled results are provided as inputs to 311 which generates predictions, based on previous learnings on training data sets, as described in the operation of 340. Various design options are computed using these predictions, at 312, and further compared with the current design in 313. Results are then ranked at 314 and stored, with relevant results written to the ledger 273. At 320, the process provides an illustration of a generative response to a user query. Here, at 321, the process receives a user query for an improved design, through user interface 140.

At 322, the process retrieves stored results from 313 and creates a generative response to the user query. At 330, the process provides an illustration of a user query to discover a provider suitable for providing a services for a specific design. At 331, the process receives this user query. Subsequently, 332 analyzes results from 310 for the current design, and proceeds to rank providers at 333, depending on their relevance and capabilities, in the context of the current design. At 334, the process then creates a generative response to the user query. At 340, the process describes an illustration of model training. Here, various content sources in component 150 are read, with further processing at 342 to label them and to generate suitable training datasets, while some datasets are retained to determine future accuracy of the model.

At 343, the process then trains a machine learning model based on the training dataset. The machine learning model may be used to evaluate packaging designs using multi-domain datasets and computes multi-objective optimization outputs, enabling use cases including structural improvement, cost reduction, material substitution, manufacturability forecasting, supply chain risk assessment, performance prediction, regulatory compliance checking, and sustainability improvement. Prediction engine 344 then uses the trained model to generate a prediction. The prediction is then checked for accuracy at 345 against a data set that was reserved for determining accuracy. This process is repeated across the training sample space, until adequate training accuracy is achieved. The model parameters are then saved, and the model is ready for use in future predictions.

In one or more embodiments, various approaches to model training and prediction can be employed. These include deterministic approaches, or non-deterministic approaches where training datasets are incomplete, or where outputs are not required to be strictly deterministic. Imputation methods can be employed to reasonably complete gaps in training data sets. Models can also include approaches based on regression, or with objectives across multiple features in the various dimensions for optimization. As multiple such objectives can exist, multiple pathways exist for the evolution of a packaging design. Random forest models are useful in some embodiments, for classification, and for determination of the most relevant features across such pathways, or if multiple such pathways are combined as part of an ensemble learning approach.

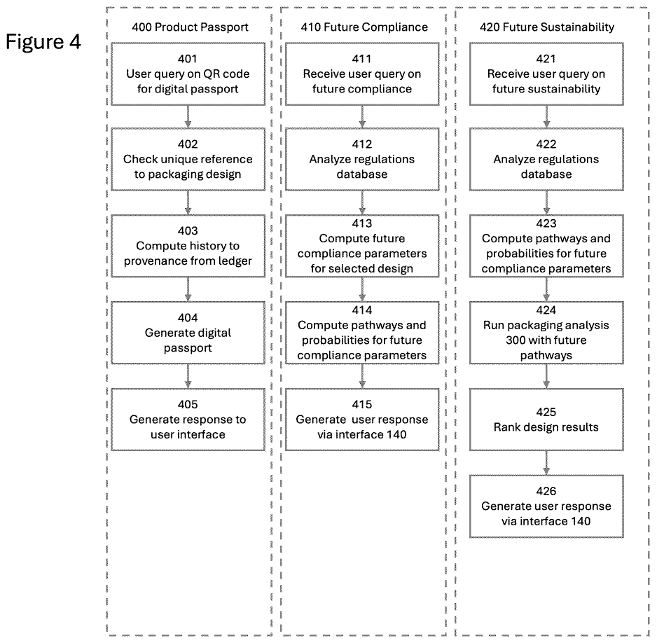

FIG. 4 is a flowchart illustration of the processes 400 for generating a product passport of a process 410 for generating actionable user response to a query on future compliance, and of a process 420 responding to a user query about actionable future sustainable pathways. Processes 400 illustrate an example scenario where a consumer scans a QR code on a packaging object, to query for its digital passport. This links to a specific URL that generates a query at 401 and causes the process at 402 to check the system 200 for the unique reference number of the packaging design and to produce its digital passport. At 403, the process looks up records in ledger 273, and computes the historical transactions for the packaging design, all the way to its provenance. At 404, the process uses this information to generate a digital passport in a format that is suitable for delivery via the user interface that made the query. At 405, the process generates the user response.

Process 410 illustrates a scenario wherein a user queries the system 200 about future compliance requirements for a packaging design. The user query is received in at 411. At 412, the process analyzes the regulations database 156, and extracts policies and parameters relevant to the selected design. At 414, the process then utilizes the prediction engine 344 to compute pathways emphasizing compliance to those regulatory requirements. This results in one or more pathways for future compliance. At 415, the process then generates a response to the user query.

Process 420 illustrates a scenario where the user makes a query about future sustainability of a packaging design. This is a more expanded query compared to the one at 410. At 421, the process receives the user query. At 422, the process analyzes the regulations database. At 423, the process computes future pathways, much as in the scenario at 410. Next, at 424, the process runs an entire packaging analysis 300, evaluating the design performance with future scenarios, resulting in one or more design options. At 425, the process ranks these options, and at 426, the process generates a user response.

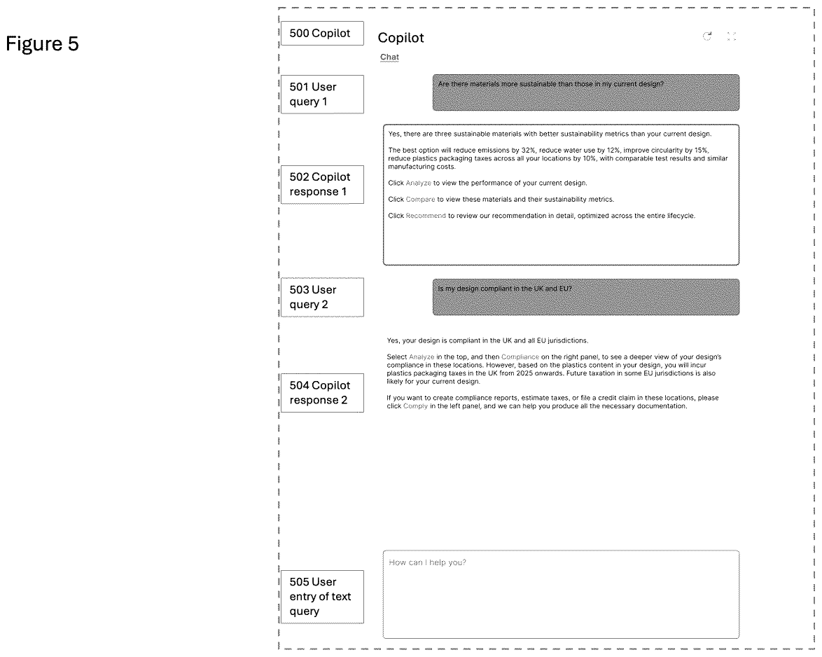

FIG. 5 is an illustration of a copilot 500, that provides an interactive user interface to request and respond to queries relating to the functionalities of SA 200. The illustration uses a textual interface, although other embodiments could use any multi-modal input and output format. For instance, a user could drag and drop a 3-dimensional packaging design into the interface and create a query. In this embodiment, component 501 illustrates a user query asking about the existence of materials that are more sustainable than a user's current design. In component 502, the copilot 500 generates a response 502 based on the illustration previously described at 320, to identify 3 designs that are more sustainable, along with various context-sensitive links within the system 200 that can provide more details for the user. The user proceeds to ask a question at 503 about the compliance of their design in the UK and in the EU. The copilot 500 responds at 504 indicating that the design is compliant, albeit with potential tax implications. The system also offers a context-sensitive link within system 200 to explore these obligations in greater detail.

Within the copilot 500, a collaborative interface is provided that enables designers, buyers, engineers, manufacturers, testers, logistics partners, and regulatory professionals to contribute data, iterate on designs, validate outcomes, and prepare packaging for production.

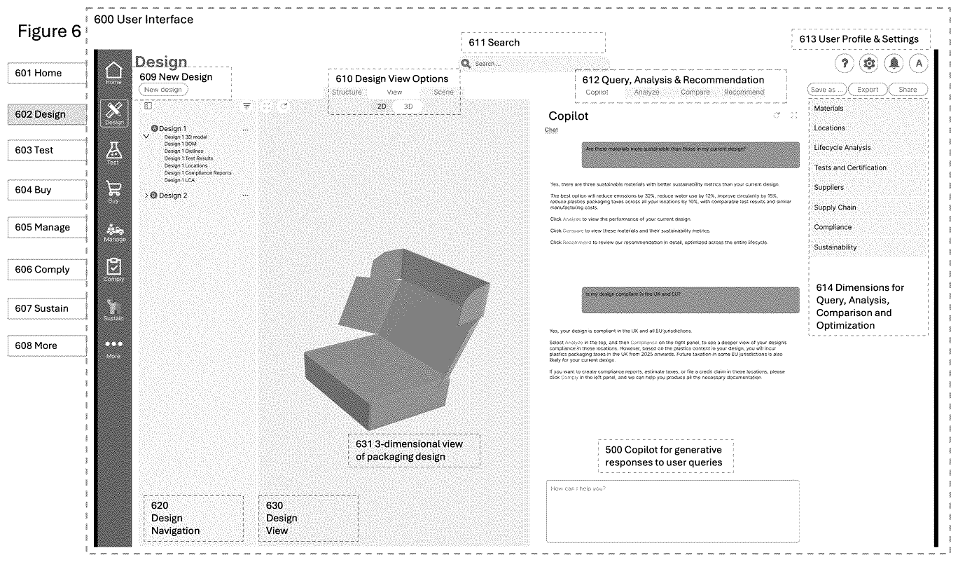

FIG. 6 is an illustration of a design functionality of a graphical user interface 600, that can be rendered through user interface 140, among other methods. In this embodiment, the user interface is a web-based interface on a computer browser, although several variations can exist for a plethora of user interface types. The left panel provides a navigational interface across key services, inspired by a subset of system services 220. Home 601 is the default landing page for the user interface in this embodiment. Design 602 is the landing page for all functionalities pertaining to packaging designs. Test 603 is the page for viewing and initiating tests on packaging designs and materials. Buy 604 is the transaction page, where purchases of services and products are initiated and managed. Manage 605 is the page where all supply chain parameters are managed after a purchase transaction, to ensure fulfilment and to track supply chain parameters such as risks. Comply 606 is the section where the compliance attributes of a design are managed, and where compliance reports are generated, along with any claims or credits. Sustain 607 manages all sustainability related aspects, metrics and pathways. Component 608 is a placeholder for surfacing additional system services.

The remainder of the illustration is with reference to the selection of the Design 602. Component 609 enables a user to input a new design into the system. Component 611 enables text-based search across the entire system 200. Component 613 is a panel for managing user profiles, indicating options for user help, settings, notifications, and user account management. Component 620 is an illustration of a design navigation interface, enabling a user to view and select one or more designs for viewing, analysis and recommendations. A design can be described by one or more sets of attributes, including but not limited to structures 2- and 3-dimensional models, bill of materials, dielines, test results, locations for manufacturing and distribution, compliance reports and LCA results.

Once a design is selected, Component 630 enables a view of the design, in one of several formats. For illustration, a 3-dimensional view is illustrated. Component 500 is a copilot as already described and provides generative response in the context of the selected design. Component 614 is a set of dimensions across which querying, analysis and recommendations are possible, and representative of the dimensions along which the artificial intelligence models perform optimization and make recommendations. The recommendations may include optimized design alternatives, material options, supplier selections, manufacturing configurations, testing needs, compliance considerations, and performance forecasts.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present implementations are to be considered illustrative and not restrictive, and the invention is not to be limited to the details given herein, but may be modified within the scope and equivalents of the appended claims. For example, the data layers and workflows described herein may be used not only for sustainability, but for general packaging industry use cases. Furthermore, the AI frameworks used by the implementations herein may be architecture and vendor-agnostic.

Those having skill in the art will appreciate that many changes may be made to the details of the above-described implementations without departing from the underlying principles of the invention. The scope of the present invention should, therefore, be determined only by the following claims.

What is claimed:

1. A system for learning, prediction, design, collaboration, transaction and interaction for processes related to objects and their supply chain, comprising:
a user interface for receiving a request and delivering information associated with a process;
an analysis engine for generating a model of a process;
a learning engine for learning features associated with a model of a process;
a prediction engine for generating one or more predictions associated with a process;
a design engine for generating structural and material designs;
a collaboration engine for determining and engaging entities associated with a process;
a transaction engine for procuring and fulfilling services from entities associated with a process; and
an interaction engine for generating communications associated with a process;
wherein one or more artificial intelligence models generate predictions of features associated with a process,
wherein one or more artificial intelligence models are trained on models of previously generated processes,
wherein one or more artificial intelligence models generate information about entities and interactions associated with a process, generate information about transactions associated with a process, and generate communications associated with a process.

2. The system of claim 1, wherein entities are objects and their constituent physical or digital parts or aspects, including materials that objects are fabricated from, design specifications, two-and three-dimensional models of objects, bill of materials, artwork and branding information, test results, certifications for specific use scenarios, supply chain values corresponding to the object at every stage of the supply chain.

3. The system of claim 1, wherein entities are individuals or groups, performing actions pertaining to other entities, objects and processes.

4. The system of claim 1, wherein objects are packaging materials or packaging objects, that enclose, protect, transport, store, brand, market, or communicate other objects.

5. The system of claim 1, wherein features include at least one of: (i) values corresponding to material specifications, including material composition, two and three dimensional descriptors such as structure, size and volume, design and brand descriptors, material performance characteristics, methods of manufacturing, and process values associated with fabrication, distribution, storage and use, (ii) locations corresponding to material fabrication, distribution, storage and use, (iii) values indicative of lifecycle analysis including emissions, water use, reuse and recycling, and environmental impact, associated with the lifecycle of the material and its derivative forms through one or more processes, (iv) test values corresponding to testing of the material for use in various conditions, (v) certification values that correspond to indications of acceptance to specified criteria, (vi) supplier values that correspond to identities, descriptors, capabilities and performance of suppliers, who are entities that can provide specific services in relation to an object or process, (vii) supply chain values that are indicative of parameters relating to processes in the supply chain, including testing, certification, supplier capabilities and performance, risks and compliance requirements, end of life responsibilities, and reporting requirements in various jurisdictions, (ix) compliance values indicative of regulatory and compliance requirements in various jurisdictions, transactions related to taxes, rebates and claims, and (x) sustainability values indicative of the sustainability and circularity of participating objects, entities, features and processes.

6. The system of claim 1, wherein the learning engine learns models that are digital representations of one or more features, entities, objects or processes, and are trained using supervised or unsupervised learning using complete or incomplete values of one or more features, entities or processes.

7. The system of claim 1, wherein the prediction engine generates predictions that are optimized across one or more features, entities, objects or processes.

8. The system of claim 1, wherein the prediction engine generates one or more predictions that describe one or more potential future pathways of progressive optimization towards a desired future state.

9. The system of claim 1, wherein the prediction engine generates one or more predictions that describe metrics related to emotional responses to one or more features, entities, objects or processes.

10. The system of claim 1, wherein the design engine engages one or more participants in the system to collaboratively design one or more features, entities, objects or processes, including at least one of: (i) evaluating an existing design to recommend improvements, (ii) suggesting one or more design alternatives as improvements to a design, (iii) suggesting future design alternatives that align with predictions of the prediction engine, (iv) virtually testing a design for parameters representative of desired use case scenarios, (v) evaluating a design for conformance to one or more test standards, (vi) evaluating a design for lifecycle parameters indicative of supply chain metrics, sustainability and circularity, (vii) incorporating user feedback into production of design modifications in iterative fashion to arrive at a design meeting user acceptance, (viii) testing a design virtually for emotional engagement from users with one or more emotional profiles, and (ix) creating variations of designs suited to one or more regional, cultural, and demographic preferences, policies or norms.

11. The system of claim 1, wherein the collaboration engine engages one or more participants in the system to collaboratively contribute to one or more features, entities, objects or processes, including at least one of: (i) evaluating learnings of the learning engine and predictions of the prediction engine, (ii) altering or adjusting values associated with the learning model to improve its learning, (iii) altering or adjusting predictions of the prediction engine to improve its predictions, (iv) evaluating scoring, voting, ranking, comments to alter or adjust values associated with the learning engine or prediction engine.

12. The system of claim 1, wherein the transaction engine recommends, initiates, facilitates and manages transactions between entities, based on optimization through the prediction engine and interaction with participating entities.

13. The system of claim 1, wherein information contributed by one or more entities, features, objects or processes are examined for provenance, ownership, and rights, and facilitation and establishment of mechanisms for attribution, compensation, and sharing of such information.

14. The system of claim 1, wherein digital representations of physical instances of entities, features, objects or processes, their relationships, interactions and communications, their modifications, analyses, comparisons, predictions, and recommendations, are maintained over time.

15. The system of claim 1, wherein interactions include bidirectional communication of information relating to one or more entities, features, objects or processes, through text, speech, audio-visual means or through any form of multi-modal time series.

16. The system of claim 1, wherein interactions relate to a packaging ecosystem, including information about materials, designs, testing, prototyping, certification, manufacturing, distribution, use, end-of-life, disposition, compliance and continuous improvement.

17. The system of claim 1, wherein interactions include the generation of information intended to meet requirements for compliance reporting in formats specified by entities requesting such reporting.

18. The system of claim 1, wherein information pertaining to one or more entities, features, objects or processes are recorded in digital form in an immutable ledger that facilitates the process of recording and sharing.

19. The system of claim 1, wherein information pertaining to one or more entities, features, objects or processes is organized, shared and accessible, to provide records of provenance and evolution of information over time.

20. A method for learning, prediction, design, collaboration, transaction and interaction for processes related to objects and their supply chain, comprising:
receiving a request and delivering information associated with a process;
generating a model of a process;
learning features associated with a model of a process;
generating one or more predictions associated with a process;
generating structural and material designs;
determining and engaging entities associated with a process;
procuring and fulfilling services from entities associated with a process;
generating communications associated with a process;
generating, using one or more artificial intelligence models, predictions of features associated with a process to optimize across the supply chain; and
recommending pathways for improvement towards sustainable outcomes.
